(19) United States
(12) Patent Application Publication
(10) Pub. No.: US 2026/0008106 A1
(43) Pub. Date: Jan. 8, 2026

(54) Z-PINCH MAGNETOHYDRODYNAMIC METAL JETTING

(71) Applicant: Lawrence Livermore National Security, LLC, Livermore, CA (US)

(72) Inventors: Jason R. Jeffries, Livermore, CA (US); Viktor Sukhotskiy, Livermore, CA (US); Benjamin Thanh Pham, Long Beach, CA (US)

(21) Appl. No.: 18/766,555

(22) Filed: Jul. 8, 2024

(51) Int. Cl. B22F 12/50; B22F 10/22; B33Y 30/00; H02K 44/02

(52) U.S. Cl. CPC B22F 12/50; B22F 10/22; H02K 44/02; B33Y 30/00

(57) ABSTRACT

An apparatus for producing drops of liquid metal for additive manufacturing comprises a reservoir for supplying liquid metal and a pressure chamber in fluid communication with the reservoir. The pressure chamber has a channel therein where compressive forces are applied on the liquid metal therein. Upper and lower electrodes apply a current through the liquid metal in the pressure chamber. This current creates an electric field that produces radially inward directed Lorentz forces on the liquid metal. This compressive force provides pressure in the longitudinal direction for ejecting the liquid metal through the orifice to form liquid metal droplets.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### BACKGROUND

### Field

The present disclosure relates generally to additive manufacturing using metal, and more particularly, to the controlled emission of droplets of molten metal from an orifice, which may be employed for such additive manufacturing.

### Description of the Related Art

Liquid metal jetting can produce small, reproducible droplets of liquid metals. Liquid metal jetting can be employed as an additive manufacturing technique wherein individual droplets of liquid metal are emitted from a small-diameter nozzle via a pressure pulse. The pressure pulse for a liquid metal can be generated, for example, externally via pneumatic pressure or a piston-like action displacing liquid.

Nevertheless, a major challenge in ejecting metal droplets is applying the pressure pulse to the liquid metal. Direct adoption of bubble-jet technologies from ink-based printers, for example, is limited by the high temperatures for melting metals to form liquid metal, and also by the large liquid regime that precludes ready access to a vapor phase.

What is needed are other approaches for achieving liquid metal jetting.

### SUMMARY

The present disclosure relates to apparatus and methods that exploit an electromagnetic response of liquid metal that allows for an internally actuated pressure inside of the metal itself. Disclosed herein is a method of creating this internal pressure within the metal using a Z-pinch magnetohydrodynamic (ZMHD) pulse. In particular, a large current pulse is caused to traverses a volume, e.g., a column, of conducting liquid metal. The current pulse induces a magnetic field through Ampere's law, and that magnetic field then interacts with the current pulse to generate radially inward Lorentz forces and resultant pressure. Currents of several hundred amperes, for example, can elicit internally directed squeezing pressures in the tens of kPa on the liquid metal volume, e.g., column. Such radial (e.g., lateral) pressures, when acting on an incompressible fluid (as liquid metals are incompressible fluids at these pressures), can result in a force directed along the longitudinal (e.g., long) axis of the liquid metal column. Moreover, if an orifice is present at one end of that column, a droplet of liquid metal can be ejected from the orifice due to this ZMHD induced radial pressure.

The Z-pinch magnetohydrodynamic method described herein utilizes the liquid metal itself as the conductor to flow high currents to produce a magnetic field around at least a portion of a volume of liquid metal. With this approach, no external actuating coil nor permanent magnet is required near the hot liquid metal to produce the magnetic field. With currents passing directly through the liquid metal to produce the magnetic field, instead of an actuating coil or large magnet, this approach enables miniaturization.

One example apparatus for additive manufacturing using liquid metal comprises an elongate pressure chamber comprising a channel extending in a longitudinal direction for liquid metal such that a length of liquid metal is within the channel. An orifice is at one end of the channel such that the liquid metal flows therethrough when sufficient internal pressure is applied to the liquid metal. The apparatus further comprises top and bottom electrodes arranged with respect to the channel to cause a current to flow along the length of the liquid metal in the channel between the top and bottom electrodes. Electronics electrically connected to the electrodes provide a current pulse along the length of the liquid metal. The current through the liquid metal induces a magnetic field that causes a radially inward pressure to be applied on the length of liquid metal due to interaction between the induced magnetic field and the current. The inwardly radial pressure is sufficient to cause metal to flow through the orifice. Droplets of liquid metal can thereby be produced for use in additive manufacturing.

Other designs and methods are possible.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1A is a schematic diagram of a volume of liquid metal and top and bottom electrodes positioned with respect to the volume of liquid metal to provide a current through the liquid metal. FIG. 1A shows the current, I, concentrated in a region of the volume of liquid metal between the electrodes. FIG. 1A also shows the magnetic field, B, produced by the current and the inwardly directed radial Lorentz forces created by the magnetic field. The bottom electrode includes an orifice for the flow of the liquid metal therethrough with application of the inwardly directed radial forces.

FIG. 1B is a schematic diagram of a cross-sectional view through the line B-B through the volume of liquid metal shown in FIG. 1A. FIG. 1B shows the region of concentrated current flow. FIG. 1B also shows the magnetic field, B, produced by the current and the radially inward directed Lorentz forces induced by the magnetic field on the region of concentrated current.

FIG. 2A is a schematic view of liquid metal contained in a pressure chamber comprising a channel formed by walls of insulating material with electrodes above and below. The top electrode comprises a ring-shaped electrode. The bottom electrode comprises a planar electrode having an orifice therein beneath the liquid metal for flow of drops of liquid metal. FIG. 2B is a cross-sectional view of the apparatus of FIG. 2A along the line B-B showing the region in which the current is concentrated.

FIG. 3A is schematic view showing liquid metal again contained in a pressure chamber comprising a channel formed by walls of insulating material with electrodes above and below. The top electrode and bottom electrodes comprise planar electrodes. The bottom electrode has an orifice therein beneath the liquid metal for flow of drops of liquid metal. FIG. 3A additionally show control electronics electrically connected to the electrodes to apply a pulse of current through the volume of liquid metal.

FIG. 3B is a plot on axes of current (Amperes, A) and temperature (in Kelvin, K) versus time (in seconds) depicting a current pulse that is delivered to the liquid metal and the resultant increase in temperature of the liquid metal that decays with time.

FIG. 4A is a schematic view illustrating a design of an apparatus for additive manufacturing using liquid metal comprising a reservoir feeding an elongate pressure chamber surrounded on lateral sides by insulating walls. Top and bottom electrodes are positioned above and below the pressure chamber to induce a current within the liquid metal within the pressure chamber. The top electrode includes an extension extending through the reservoir and to the pressure chamber. The bottom electrode includes an orifice for the flow of the liquid metal with application of the inwardly directed radial Lorentz forces produced by the current induced magnetic field on the region of concentrated current within the liquid metal.

FIG. 4B is a cross-sectional view of the top electrode of the apparatus shown in FIG. 4A through the line B-B.

FIG. 4C is a cross-sectional view of the apparatus shown in FIG. 4A through the line C-C showing the reservoir and the sidewalls forming the reservoir.

FIG. 4D is a cross-sectional view of the bottom electrode of the apparatus shown in FIG. 4A through the line D-D showing the orifice for flow of liquid metal therethrough for the formation of liquid metal droplets.

FIG. 5 is a schematic view illustrating another design comprising an elongate pressure chamber surrounded on lateral sides by insulating walls. Top and bottom electrodes are positioned above and below the pressure chamber to induce a current within the liquid metal within the pressure chamber. The top electrode includes an extension extending into the open region between the insulating walls and to the pressure chamber. The bottom electrode includes an orifice for the flow of the liquid metal with application of the inwardly directed radial Lorentz forces produced by the current induced magnetic field on the region of concentrated current within the liquid metal.

FIG. 6 is a schematic view of a configuration similar to that shown in FIG. 4A with the reservoir off to the side as opposed to over the pressure chamber.

FIG. 7 is a schematic view of another configuration similar to that shown in FIG. 6 with the reservoir off to the side as opposed to over the pressure chamber.

FIG. 8 is a schematic view of another configuration similar to that shown in FIG. 5, however, showing a reservoir over the pressure chamber.

FIG. 9A is a schematic view of another configuration similar to that shown in FIG. 8 with a reservoir over the pressure chamber, however, the top electrode extends in from one side.

FIG. 9B is close-up of the top electrode extending in from one side of the apparatus for additive manufacturing shown in FIG. 9A. FIG. 9A shows a gasket such as a metal gasket (e.g., copper) used to provide an effective seal on the top and bottom of the electrode.

FIG. 9C is close-up of the bottom electrode for the apparatus for additive manufacturing shown in FIG. 9A. FIG. 9C shows a gasket such as a metal gasket (e.g., copper) used to provide an effective seal on the bottom electrode.

FIG. 10 is a schematic view of another configuration similar to that shown in FIG. 9 with a reservoir over the pressure chamber, however, the top electrode includes a fill valve comprising a hole (not shown) in the electrode.

FIG. 11 is a schematic view of another configuration similar to that shown in FIG. 10 with a reservoir over the pressure chamber, however, fill lines on opposite sides of the top electrode are used to supply liquid metal to the pressure chamber rather than a valve or hole in the top electrode.

FIG. 12A is a schematic cross-sectional view of a “fill valve” used to flow liquid metal from the reservoir to the pressure chamber. The fill valve is configured to reduce backflow. The irregular contouring on the walls of the fill valve allows flow in the forward (+Z) direction while inhibiting flow in the reverse direction (−Z). This fill valve is a two-part valve formed by one insert held in place within an opening in the apparatus to form the valved fluid flow regions or channels in the gap between the insert and, for example, sidewalls of the apparatus.

FIGS. 12B and 12C are schematic bottom and top views of the contoured fill valve depicted in FIG. 12A. FIG. 12B shows the bottom where three tabs connect the insert to the surrounding portions (e.g., sidewalls) of the apparatus thereby creating flow regions or channels in the gap between the insert and the surrounding portions (e.g., sidewalls) of the apparatus thereby forming the valve.

### DETAILED DESCRIPTION

This disclosure provides apparatus and methods for additive manufacturing using liquid metal. Liquid metal jetting is a promising tool for additive manufacturing and powder feedstock fabrication. Fundamentally, liquid metal jetting sources small, reproducible droplets of liquid metals, which can be used to fabricate larger metal components via additive manufacturing. A challenge in ejecting metal droplets, however, is applying a pressure pulse to the liquid metal.

Various methods and apparatus are provided herein for providing pressure to a volume of liquid metal to drive liquid metal through an orifice to create droplets. Liquid metals possess the quality of high conductivity. Accordingly, current can be driven through the liquid metal and magnetohydrodynamic actuation methods may be employed to generate pressure for forcing the liquid metal through an orifice to create liquid metal droplets for additive manufacture.

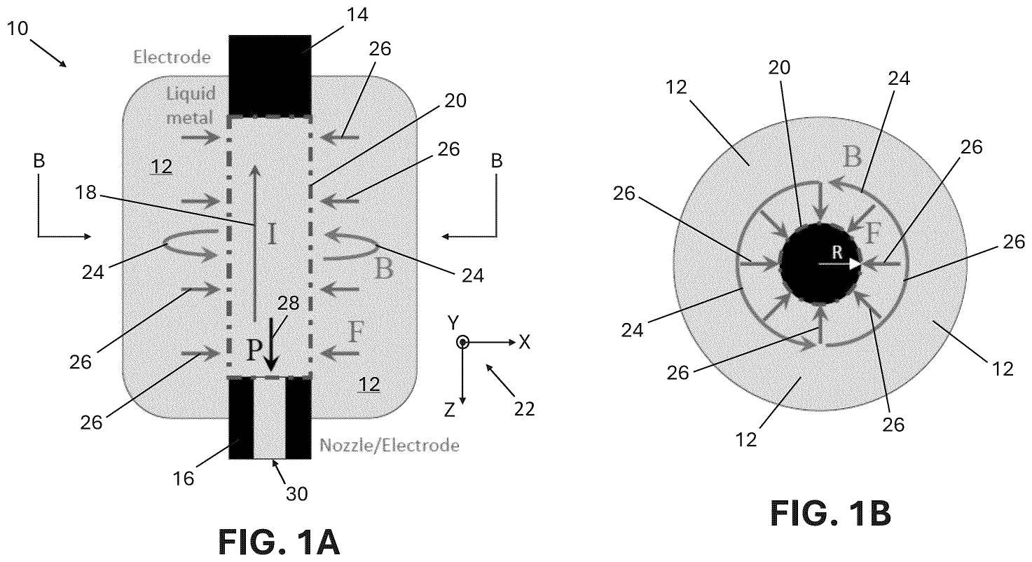

For example, as illustrated by the system or apparatus 10 shown in FIGS. 1A-1B, a volume of liquid metal 12 can be formed, for example, by heating the metal using a heater such as external heating methods. The liquid metal can be heated, for example, by placing the apparatus in an oven. In some implementations, the apparatus and/or metal can be heated via an induction loop heater that surrounds the apparatus. Cartridge heaters can also be included in the walls of the apparatus to provide heating.

A wide variety of metals may be employed for the metal jetting. The liquid metal may, for example, comprise soldering alloys such as indium, gallium, tin, lead, bismuth, cadmium, zing, antimony or combinations thereof. The metal may also comprise aluminum or aluminum alloys and/or brass/bronze and/or the constituent thereof. For example, the metal may comprise copper, zinc, aluminum, nickel, tin, silver or combinations thereof. The metal may comprise precious metals such as gold, copper, silver, steels, superalloys, or high-entropy alloys such as iron, cobalt, nickel, chromium, magnesium, manganese or others. The metal may comprise rare-earth metals such as Cerium to Dysprosium. The liquid metal should not be limited to these examples as other metals may be employed. The metal may comprise metal having a melting point of no more than 2000° C. although metals with higher melting points may also be employed. As discussed above, melted metal is conductive and can therefore conduct electricity and facilitate generation of a current pulse therethrough.

Electrodes 14, 16 can be placed in contact with different portions of the volume of liquid metal 12 to drive a current through the liquid metal between the electrodes. FIG. 1A, for example, shows top and bottom electrodes 14, 16, for example, at top and bottom locations, respectively, with regard to the volume of liquid metal 12. The electrodes will likely have a conductivity that is roughly 2-10 times higher than the liquid metals. This value can vary depending on the nature of the liquid metal being printed. For example, a metal like steel will have relatively low conductivity compared to the electrodes. In contrast, in various implementations, the insulating walls of the current-carrying chamber or the apparatus will have conductivities that may be several orders of magnitude lower than the electrodes or the liquid metal. The liquid metal may be contained, for example, using tungsten or alloys thereof although other materials may be employed. The reservoir, for example, may comprise tungsten or alloys thereof although other materials may be used.

A voltage is be applied across the electrodes 14, 16 or otherwise a current 18 may be driven between the electrodes. The electronics deployed may comprise, for example, a current source or current supply. Such a current supply may be capable of high currents at low voltages (as the resistance of the liquid metal that gets ZMHD pulsed is not high). One or more external cable/wires connect the electrodes to the current supply. These external cable/wires are also capable of carrying and withstanding the current pulses of 100s of amps as well. Current 18 can be assumed to flow between the electrodes 14, 16 such as for example as shown in FIG. 1A, although such a model is a simplification. Likewise, without subscribing to any particular scientific theory, in this example, current 18 can be assumed to be concentrated in a region 20 between the electrodes 14, 16.

In FIG. 1A, the electrodes 14, 16 are spaced apart from each other by a longitudinal distance parallel to the Z direction depicted in the XYZ coordinate system 22 shown. The region 20 where the current 18 is concentrated also extends in this longitudinal distance (e.g., parallel to the Z direction) from the first or top electrode 14 to the second or bottom electrode in this configuration. The region 20 of concentrated current flow 18 is also depicted as having a lateral width, although the current 18 can have different distributions depending on the chosen geometries of the apparatus and the electrodes. In the configuration shown in FIGS. 1A and 1B, the region 20 of where current 18 is concentrated is a column or right circular cylinder, although other shapes are possible. The shape of this region 20, may for example be influenced by the cross-section or footprint of one or both electrodes 14, 16 (e.g., in a plane parallel to the XY plane in the example shown in FIGS. 1A-1B).

Pursuant to Ampere's Law, the current 18 will produce a magnetic field, B, 24 according to the following equation:

$$∮ Bdl = {μ}_{o} I \qquad ( 1 )$$

where B is the magnetic field vector, l is length, I is current, and μₒ is the permeability of free space. For the simplified model shown in FIG. 1, the region or column 20 of concentrated current flow can be likened to a wire. For a current traversing a wire, Biot-Savart's Law provides that

$$B = {μ}_{o} I / 2 π r \qquad ( 2 )$$

where B is the magnetic field, I is current, μₒ is the permeability of free space, and r is the distance from the wire to the point where the magnetic field is being estimated. The magnetic field, B, 24 would be expected to increase from the center of the region or column 20 of concentrated current 18 laterally to the lateral edges of current flow region and then fall off with distance from the region of concentrated current flow. Such a result is dictated by Maxwell's equations and the Biot-Savart law, for example, when integrated from the center of the region or column of liquid metal where the current is flowing to the outer radius of region or column. This integration (assuming a homogenous column of liquid metal) may result in a linearly increasing B field with distance away from the center of the column, a maximum B at the edge of the column, and a field that falls off as 1/r with distance from the edge of the column (which depending on the particular configuration may be out into the apparatus or empty space).

Regardless, a magnetic field B, 24 is produced by the current 18 flowing through the region 20 of concentrated current within the volume of liquid metal 12. As illustrated, this magnetic field, B, 24 is directed tangential to the longitudinal direction of current flow (e.g., in the Z direction). Similarly, this magnetic field, B, 24 is directed tangential to the length of the region or column 20 of where current 18 is concentrated, again, tangential to the Z direction as shown in FIG. 1.

This magnetic field B, 24 will produce a radially inward Lorentz force 26 on the current flow region or column 20. The following equations are applicable to a Lorentz force produced by moving charge or currents, the first equation directed to the force on moving charge in the presence of an orthogonally directed magnetic field.

$$F = q v \times B \qquad ( 3 )$$

where F is the Lorentz force, q is charge, v is the velocity vector, B is the magnetic field vector.

For a current flowing, for example, through a wire

$$F = Il \times B \qquad ( 4 )$$

where I is the current and l is the length along which the current flows.

Likewise, the region or column 20 of the volume of liquid metal where the current 18 is concentrated will experience a Lorentz force 26 directedly radially inwardly thereon compressing the liquid metal 12 in opposing radial directions (e.g., ±X directions, ±Y directions, and other radial directions) as illustrated in FIG. 1. These forces 26 directed radially inward on the length of the region/column 20 of concentrated current 18 within the volume 12 of liquid metal induce pressure, P, 28 on the liquid metal in the longitudinal direction, for example, in the Z direction shown in FIG. 1A.

As illustrated in FIG. 1A, the bottom electrode 16 comprises a nozzle having an orifice 30 therein. The pressure, P, 28, produced in the longitudinal direction, e.g., Z direction, forces liquid metal through the orifice 30. With application of pulses of such pressure, P, 28, droplets are output through this orifice 30. Such pulses of pressure, P, 28, may be created by pulsing the current 18, which pulses the resultant magnetic field, B, 24 and the Lorentz forces 26 compressing the liquid metal in the region or column 20 of concentrated current flow.

Thus, pulses of current along a longitudinal direction, e.g., Z direction, through a liquid metal column creates a pulsed magnetic field that circles around the column (around Z) and interacts with the current that created it to generate an radially inward Lorentz force that exerts a constricting pressure on the column of liquid, which effectively exerts a pressure along the Z direction both in the upward and downward (±Z) directions. The force upward is countered by either the upper electrode or the weight of the liquid above and the downward force pushes on a small amount of liquid in the nozzle orifice so as to be ejected as a droplet.

Accordingly, in various implementations described herein, radially inward compression along the length of the region 20 where current 18 is concentrated causes pressure 28 to be applied to the end of the region or column 20 proximal to the bottom electrode 16. The column of liquid metal in this region 20 is effectively squeezed by the magnetically induced radially inwardly forces 26 so as to produce pressure 28 in the longitudinal direction. This pressure 28 acts as a pump on the top of the nozzle driving a volume expansion in the nozzle and ejection of conducting material (e.g., liquid metal) from the orifice 30.

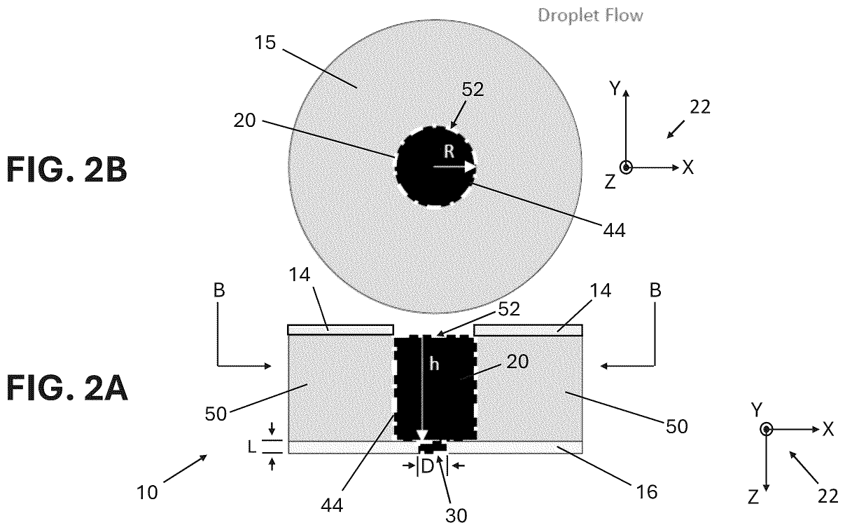

Another system or apparatus 10 for metal jetting by providing a current 18 through a volume 12 of liquid metal is shown in FIGS. 2A-2B. In the example shown in FIGS. 2A-2B, the liquid metal 12 is contained within a pressure chamber 44 comprising a channel 52 formed by insulating walls 50. The insulating walls 50 comprise insulating material. The insulating walls 50 have sidewalls that form the channel 52 and confines the liquid metal on opposite sides. As shown in FIGS. 2A and 2B, the channel 52 with liquid metal therein and thus the region 20 where current flow 18 is concentrated is a column or right circular cylinder, although other shapes are possible. As discussed above, the shape of this region 20 may, for example, be influenced and/or determined by the cross-section or footprint of one or both electrodes 14, 16 (e.g., in a plane parallel to the XY plane) and/or the volume of liquid metal, which here is contained within the channel 52. In this example, the shape of the channel 52 in which the liquid metal is contained forms a column or right cylinder (e.g., right circular cylinder) as illustrated by the two views shown in FIGS. 2A-2B. Accordingly, the pressure chamber 44 and region 20 of concentrated current flow is a column or right circular cylinder.

First and second (e.g., top and bottom) electrodes 14, 16 are additionally included to direct a current 18 through the liquid metal within the channel 52. In this design, the top electrode 14 is a ring electrode with an opening therein. The liquid metal makes electrical contact with the top electrode 14, in this design, along the inner wall or edge of the opening in the ring electrode. The conductivity of the liquid metal is so high that distribution of current is not sensitive to the geometry of the electrode in this configuration. The top electrode 14 has a voltage, and the liquid metal at that height conforms to this potential, making the top electrode the basis for an equipotential plane. The same situation applies for the bottom electrode 16, which has a small orifice 30 therein. These two effectively equipotential planes that cap the top and bottom of the cylindrical section 20 of liquid metal provide a largely uniform current 18 along the radius of the column.

In this example design, the pressure chamber 44 and region 20 of concentrated current through the liquid metal 18 has a longitudinal extent or length (e.g., in the Z direction) or height, h, that is influenced and/or determined by the separation between the top and bottom electrodes 14, 16. As referenced above, the bottom electrode 16 includes an orifice 30 through which liquid metal may pass when radially inward forces 36 are applied to the liquid metal within the region or column 20 of concentrated current 18. Also as discussed above, this radially inward compression induces a pressure, P, 28 in the longitudinal direction (e.g., parallel to the Z direction) and causes liquid metal to flow through the orifice 30. As illustrated, the orifice 30 has a lateral extent (e.g., diameter, D), which may, for example, be in the X or Y direction, and a length, L, e.g., in the Z direction. In this design, the bottom electrode 16 and the orifice 30 (e.g., the length, L) is thinner (e.g. in the Z direction) than the channel of liquid metal and the region 20 of concentrated current 18 between the top and bottom electrodes 14, 16. In various implementations, the lateral extent (e.g., diameter, D) of the orifice 30, which may, for example, be in the X or Y direction, may be 0.01 mm, 0.02 mm, 0.03 mm, 0.04 mm, 0.05 mm, 0.06 mm, 0.07 mm, 0.08 mm, 0.09 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.5 mm, 5.0 mm or any range between any of these values or possibly larger or smaller in size. In some implementations the length, L, or thickness of the orifice 30 (e.g., in the Z direction) is 1, 2, 3, 4, 5, 6, 8, 9 10, 11, 12, 14, 15 times the diameter of the orifice or any range formed by any of these value or approximately thereto and possibly longer or shorter or thicker or thinner. In contrast, the distance separating the electrodes 14, 16 and/or the thickness, length, or height, h, of the pressure chamber 44 and/or region 20 of concentrated current 18 through the liquid metal (e.g., in the Z direction), which may also correspond to the length of the channel 52, may be 2 mm, 3 mm, 4 mm, 5 mm, 6 mm, 8 mm, 10 mm, 12 mm, 14 mm, 15 mm, 16 mm, 18 mm, 20 mm, 22 mm, 25 mm, 28 mm, 30 mm, 35 mm, 40 mm, 45 mm, 50 mm or in any range formed by any of these values or possibly larger or smaller. The width or lateral extent (e.g., twice the radius, R) of the pressure chamber 44 or region 20 of concentrated current 18 through the liquid metal, which may correspond to the width of the channel 52, (e.g., in the X or Y direction) may be 0.1 millimeters (mm), 0.2 mm, 0.3 mm, 0.4 mm, 0.5 mm, 0.6 mm, 0.8 mm, 1.0 mm, 1.2 mm, 1.4 mm, 1.5 mm, 1.6 mm, 1.8 mm, 2.0 mm, 1.2 mm, 1.5 mm, 1.8 mm, 2.0 mm, 2.2 mm, 2.5 mm, 2.8 mm, 3.0 mm, 3.5 mm, 4.0 mm, 4.5 mm, 5.0 mm or any range formed by any of these values or possibly larger or smaller.

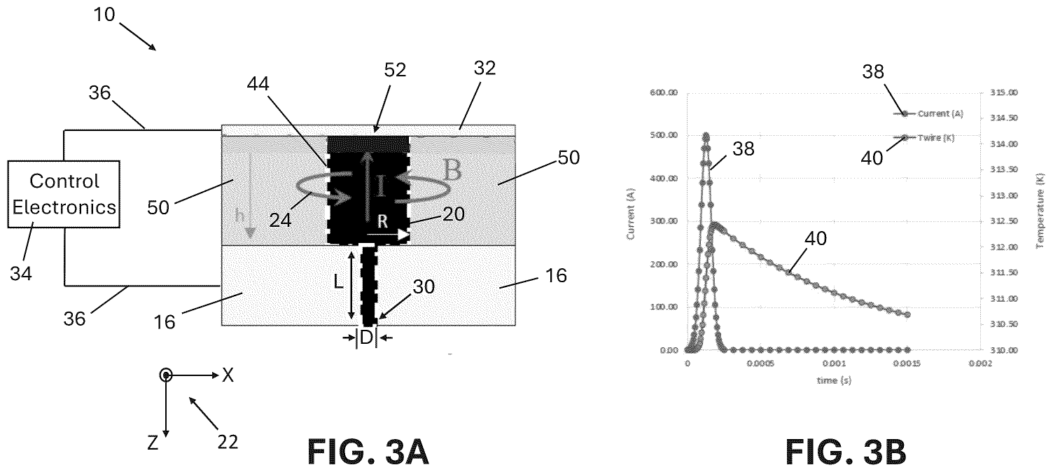

Another example system 10 is shown in FIGS. 3A and 3B wherein the liquid metal is contained within pressure chamber 44 comprising a channel 52 with top and bottom electrodes 14, 16 above and below to drive current 18 through the liquid metal in the channel. The top and bottom electrodes 14, 16 both comprise planar electrodes. The bottom electrode 16 has an orifice therein beneath the liquid metal for flow of drops of liquid metal. In the example shown, the thickness of the electrode 16 and the length, L, of the orifice 30, exceed the lateral extent (e.g., diameter) D, of the orifice.

FIG. 3A also shows control electronics 34 configured to direct the current, I, 18, through the liquid metal. One or more electrical lines 36 (cables, wires, leads, conductive paths, etc.), for example, are connected from the control electronics to the electrodes 14, 16 to apply electrical power such as current pulses and/or voltage pulses to the liquid metal. In particular, the current 18 is shown concentrated in the pressure chamber 44 and/or region 20 of liquid metal contained within the channel 44 in the insulating material 50. As illustrated, this pressure chamber 44 and/or region of current flow 20 and/or channel 52 has a lateral extent (e.g., in the X direction) that is 2R, where R is shown as the radius of the column or right circular cylinder in the configuration shown in FIG. 3A. The pressure chamber 44 and/or region of current flow 20 also has a height which is the longitudinal distance or height, h, e.g., in the Z direction, which in this case coincides with the longitudinal distance separating the first and second, top and bottom electrodes 14, 16 as well as the thickness of the insulating material and the length or thickness of the channel 44 therein. The current 18 is shown inducing a magnetic field, B, 24, which as discussed above produces radially inward forces 26 on the region 20 of concentrated current flow through the liquid metal. Such radially inward compression causes a pressure 28 in the longitudinal direction, for example, toward the orifice 30 to eject liquid metal through the orifice. In various implementations, pulses of current 18 produce a pulsed magnetic field, B, 24 which cause pulsed compression and result in droplets of liquid metal being output through the orifice 30.

In various implementations, therefore, the control electronics 34 is configured to direct current pulses through the liquid metal, for example, in the channel 42 and likewise in the pressure chamber 44 and through the region or column 20 as shown. In various implementations, the control electronics 34 comprises a power supply such as a current supply or current source and may comprise a voltage supply that can source and/or sink current, e.g., large amounts of current. In various implementations, the electronics 34 are capable of providing pulse widths of 80, 90, 100, 200, 300, 400, 500, 600, 700, 800, 900, 1000, 1100, 1200 microseconds or any range formed by any of these values (e.g., from 100-1000 microseconds), or possible shorter or longer. Such pulse timing may be commensurate with the fluid properties of liquid metals. In various implementations, the current 18 is hundreds of amps. For example, the current pulse may, for example, have a peak, in the range from 100 to 1000 Amps (A) in some cases. The current 18 (e.g., peak of current pulse) may, for example, be 80 A, 90 A, 100 A, 200 A, 300 A, 400 A, 500 A, 600 A, 700 A, 800 A, 900 A, 1000 A, 1100 A, 1200 A, 1400 A, 1500 A or in any range formed by any of these values or possibly larger or smaller.

FIG. 3B shows an example current pulse 38. In particular, FIG. 3B shows the expected current pulse for a ZMHD droplet ejection. FIG. 3B also shows a simple calculation of the temperature rise expected from Joule heating for that current pulse. The temperature rise is relatively small, amounting to only a few degrees C. Accordingly, this temperature rise is likely not large enough to generate substantial thermal expansion. Additionally, the temperature has a decay constant that can be estimated to set droplet frequencies. For example, for consistency, the different droplets may start from the same initial condition, such as temperature. This temperature plot shows that return to the baseline temperature is expected in 2-3 milliseconds (ms). Accordingly, a droplet frequency of hundreds of Hertz would be expected to be achievable. For example, the droplet frequency may be 80 Hz, 90 Hz 100 Hz, 200 Hz, 300 Hz, 400 Hz, 500 Hz, 600 Hz, 700 Hz, 800 Hz, 900 Hz, 980 Hz, 990 Hz, or any range formed by any of these values or possibly larger or smaller.

As shown in FIG. 3B, the current pulse 38 has a pulse width on the order of microseconds, e.g., 100 μsec full width half maximum (FWHM). The pulse width may, for example, be 20 μsec, 50 μsec, 100 μsec, 150 μsec, 200 μsec, 250 μsec, 300 μsec, 350 μsec, 400 μsec, 450 μsec, 500 μsec, 550 μsec, 600 μsec, 800 μsec, 900 μsec, 1000 μsec, 1.1 milliseconds (msec), 1.2 msec, 1.5 msec or any range between any of these values or possibly higher or lower. As discussed above, the current pulse will induce a magnetic field 24 that will produce radially inward compressive Lorentz forces 26 and squeeze liquid metal through the orifice 30 to selectively form and output metal drops. For example, a droplet may be output with each pulse in some implementations. The plot in FIG. 3B also shows the estimated increase in temperature from a simplified thermal model produced by the current pulse 38. See temperature curve 40. As illustrated, the current pulse 38 causes a small increase in temperature that decays back towards equilibrium on a timescale on the order of 10 pulse widths.

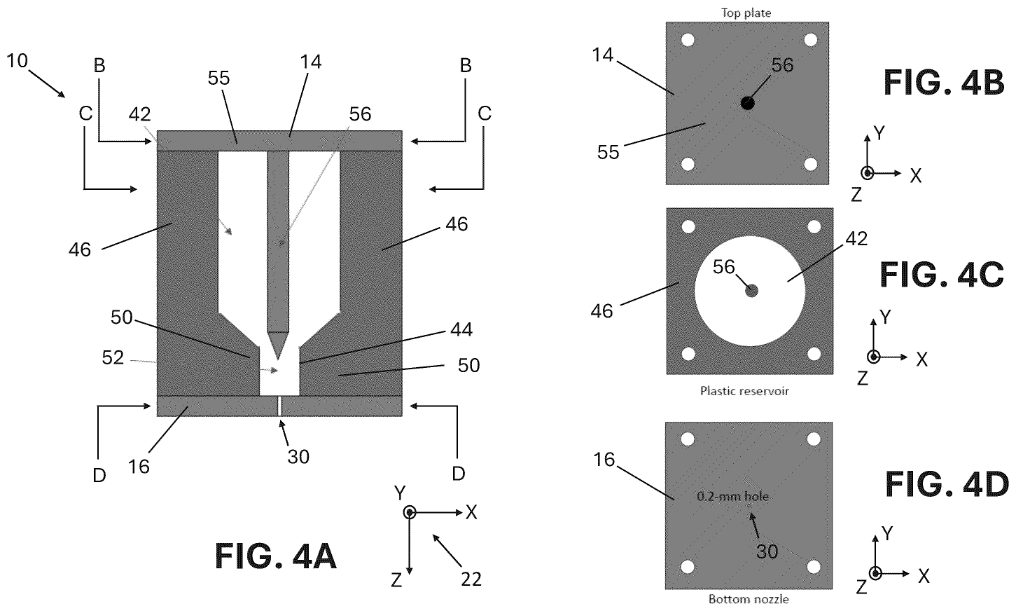

As illustrated in FIG. 4A, various implementations of the liquid metal additive manufacturing or jetting apparatus 10 shown herein include 1) a reservoir 42 to hold the liquid metal; 2) a pressure chamber 44 configured to receive liquid metal from the reservoir; 3) first and second current electrodes 14, 16 arranged to direct a current through at least a portion of the metal; and 4) an orifice opening 30 located in a position with respect to the electrodes such that the current flowing between the first and second electrodes provides pressure 28 to induce liquid metal in the pressure chamber to pass through the orifice.

The reservoir 42 comprises an open region for storing liquid metal to be provided to the pressure chamber 44 for ejection through the orifice 30. In various implementations, the reservoir 42 is larger than the pressure chamber 44. The reservoir 42 may comprise and/or be formed at least in part by reservoir walls 46. These walls 46 may comprise sidewalls. These walls 46 may be arranged to provide the open region of the reservoir in which liquid metal is contained. In various implementations, this open region, is larger than the pressure chamber 44. In some implementations, these walls 46 comprise electrically insulating material.

The pressure chamber 44 comprises a channel 52 therein such that a length of liquid metal is within the channel. The pressure chamber 44 may, for example, comprise a conduit comprising insulating walls 50 forming the channel 52 therebetween. Likewise, the pressure chamber 44 may comprise insulating walls 50 and a channel 52 between the insulating walls. In some implementations, the pressure chamber 44 is included in the conduit, which may comprise insulating walls 50 and an open channel 52 therein. Liquid metal may be in the conduit and an electric current 18 may be applied to liquid metal in the conduit using the electrodes 14, 16. A region 20 of concentrated current 18 may be in the conduit and may produce a magnetic field 24 that applies radially inward force 26 (and pressure) on at least a portion of the liquid metal squeezing the liquid metal toward the orifice 30.

In some designs, the pressure chamber 44 and/or the channel 52 is elongate. For example, the pressure chamber 44 and/or the channel 52 may have a length, thickness, or height, e.g., in the longitudinal direction (e.g., Z direction) that is larger than the lateral dimension, e.g., width, diameter, twice the radius (e.g., in the X direction). In various implementations, the first and second electrodes 14,16 are separated from each other in the longitudinal directional, the current 18 flows in the longitudinal direction, the pressure 28 resulting from the current being applied between the first and second electrodes that causes the liquid metal to flow through the orifice 30 is in the longitudinal direction or any combination of these.

The first and second electrodes 14, 16 are arranged with respect to the pressure chamber 44 and/or the channel 52 to apply a current 18 through at least a portion of the liquid metal in pressure chamber, e.g., in the channel. The first electrodes 14 may, for example, be in any one or more of the pressure chamber 44, conduit or channel 52 and/or at the entrance to any one or more of the pressure chamber 44, conduit and/or channel 52. Similarly, second electrodes 16 may be in any one or more of the pressure chamber 44, conduit or channel 52 and/or at the exit of to any one or more of the pressure chamber 44, conduit and/or channel 52.

In the example system 10 shown in FIG. 4A, the first or top electrode 14 is elongate or at least comprises an elongate portion that extends into the pressure chamber 44, conduit and/or channel 52 or at least to the entrance of the pressure chamber 44, conduit and/or channel 52. In particular, the first or top electrode 14 and/or the elongate portion thereof has proximal and distal ends, wherein the distal end extends into the pressure chamber 44, conduit and/or channel 52 or at least to the entrance of the pressure chamber 44, conduit and/or channel 52. In the example shown in FIG. 4A, the first or top electrode 14 is converging or pointed at the distal end thereof although the shape need not be so limited.

In the example shown in FIG. 4A, the second electrode 16 is planar although other shapes are possible. In the example shown, the second electrode 16 also has the aperture or orifice 30 therein for flow of liquid metal there through. See also FIG. 4C, which shows a cross-section through the second electrode 16, which may be referred to herein as the lower electrode or bottom electrode 16 in certain configurations where the first and second electrodes 14, 16 are spaced apart in the longitudinal direction, e.g., Z direction. Accordingly, in various implementations, the orifice 30 is closer to the second electrode (e.g., lower or bottom electrode) 16 than the first electrode (e.g., upper or top electrode) 14.

As described above, the first and second electrodes 14, 16 are arranged such that a current 18 flows therebetween. This current 18 will induce a magnetic field 24 and produce forces 26 exerted on the liquid metal in a plurality of radial inward directions. The compressive force results in pressure 28 toward the orifice 30 causing liquid metal to flow therethrough. Accordingly, the first and second electrodes 14, 16 and orifice 30 are arranged such that this pressure 28 is in the direction (e.g., longitudinal or Z direction) toward the orifice.

In some implementations, the first and second electrodes 14, 16 are arranged so as to be separated by a longitudinal distance such that current flows in a longitudinal direction (e.g., Z direction) and the orifice 30 is positioned such that pressure 28 is applied in the longitudinal direction toward the orifice. The orifice 30 may be placed downstream of this longitudinally directed pressure 28 such that liquid metal flows through the orifice.

In some implementations, the first electrode 14 is position above the second electrode 16. The first and second electrodes 14, 16 may likewise be referred to as upper and lower electrodes, respectively. Similarly, the first and second electrodes 14, 16, may likewise be referred to as top and bottom electrodes respectively.

In some designs such as shown in FIGS. 1-4, the first electrode 14 is positioned above the second electrode 16 such that current 18 flows between first electrode and second electrodes in a vertical direction. Pressure 28 may in such configuration be exerted downward. Additionally, the orifice 30 may be located with respect to the first and second electrodes 14, 16 and/or the current 18, for example, beneath the first electrode and downstream of the pressure 28 resulting from the radially inward compressive forces 26 such that metal liquid or fluid is forced therethrough. The longitudinal direction, e.g., Z direction, may correspond to the vertical direction in such designs.

As discussed above, in various designs, the current flows in a direction parallel to the direction of droplet ejection. The current makes a squeezing force on the liquid metal that pushes the metal along the axis of the orifice (e.g., Z direction), ejecting a droplet along that same axis.

In certain implementations, however, the pressure chamber 44 and orifice 30 configuration provide current flow in some other direction such as not along the axis of the nozzle or orifice. The electrodes 14, 16 may, for example, be oriented differently such that the current flows at an angle with respect to the vertical directions, for example, with respect to the vertical and horizontal directions.

As illustrated in FIG. 4A, the reservoir 42 for liquid metal may be in fluid communication with the pressure chamber 44. In the example shown, the open region of the reservoir 42 between the sidewalls 46 of the reservoir is connected to the channel 52 of the pressure chamber 44 between the sidewall 50 thereof. A path is provided from the reservoir 42 to the pressure chamber 44 for flow of liquid metal from the reservoir to the pressure chamber. In the examples shown in FIG. 4A, the reservoir 42 is disposed with respect to the pressure chamber 44 such that the liquid metal is gravity fed from the reservoir into the pressure chamber. In particular, the reservoir 42 is above the pressure chamber 44. In the example shown, the reservoir 42 is directly above the pressure chamber 44. In this or other designs, however, the apparatus 10 may include a pressure source configured to apply pressure to the liquid metal in the reservoir 42 to aid in feeding liquid metal from the reservoir into the pressure chamber 44. An overpressure of inert gas may, for example, be employed. Pressures on the order of about a few pounds per square inch (PSI) may contribute to the movement of the fluid, e.g., liquid metal, into the pressure chamber. Accordingly, the pressure source may comprise a gas cylinder given the low pressure and low volume, however, other sources may be used.

In various implementations, the system 10 includes a heater configured to maintain the metal in liquid state. A wide range of heaters may be employed. For example, the apparatus could be inside of an oven furnace. Such ovens or furnaces may comprise resistive heaters although microwave based heaters may also potentially be employed. In such designs, the apparatus itself may not include heaters. However, the apparatus could also have resistive cartridge heaters or wire-wound coils embedded therein to provide the heat. The apparatus could also be encircled with an RF field coil to provide inductive heating. Other types of heaters and/or arrangements for heating the metal are possible.

As illustrated in FIG. 4A, upper or top electrode 14 comprises a planar layer or portion 55 as well as an elongate conductor or elongate conductive portion 56 that extends within the reservoir 42. In this example design, the elongate conductor or conductive portion 56 has a shape of a right circular cylinder. FIG. 4B depicts a cross-section parallel to the XY plane through the upper or top electrode 14. This cross-section shows both the planar portion 55 as well as the elongate conductive portion 56, which in this example, has a circular cross-section.

Most of the open region of the reservoir 42 shown in FIG. 4A is a right-circular cylinder. Similarly, the sidewalls 46 or at least the inner walls of the sidewalls exposed to the open region are in the shape of a right-circular cylinder in this example. FIG. 4C depicts a cross-section parallel to the XY plane through the open region of the reservoir 42. This cross-section shows the circular open region of the reservoir 42 at that level. This cross-section also shows the elongate conductive portion 56 of the electrode 14 having a circular cross-section in this example.

As illustrated, the pressure chamber 44 is below the reservoir 42 and in this example, at the bottom or base of and connected to the reservoir. In this design, the reservoir 42 has a funnel shape in the lower portion thereof proximal the pressure chamber 44. The sidewalls 46 slope inward in the lower portion closer to the pressure chamber 44. In this example design, the pressure chamber 44 has the shape of a right circular cylinder. The inner walls of the sidewalls 50 that form the pressure chamber 44, the conduit, and the channel 52 therein are shaped as a right circular cylinder in this example design.

The lower electrode 16 is at the bottom or base of the pressure chamber 44, the conduit, and the channel 52. The lower or bottom electrode 16 comprises a layer, for example a planar layer in this example. The lower or bottom electrode 16 includes an opening therein comprising the orifice 30 through which the metal flows when pressure 28 is produced by the current induced radially inward Lorentz forces 26. FIG. 4D depicts a cross-section parallel to the XY plane through the lower electrode 16. This cross-section shows the opening or orifice 30 therein, which has a circular cross-section in this example design.

As discussed above, the upper and lower electrodes 14, 16 are arranged with respect to channel 52 to apply a voltage across the length of liquid metal in the channel to cause a current 18 to flow along the length of the liquid metal in the channel between the electrodes. In the example design shown in FIG. 4A-4D, the first and second electrodes 14, 16 span a longitudinal extent, height, length, or thickness (e.g., in the Z direction) of the pressure chamber 42, conduit and/or channel 44. The first and second electrodes 14 16, for example are at the proximal and distal or top and bottom ends, respectively, of the, e.g., right cylinder shaped, pressure chamber 42, conduit and/or channel 44. The distal end of the upper electrode is at the top of the pressure chamber 42, conduit and/or channel 44. As discussed above, in this example, the upper electrode 14 comprises an elongate portion 56 and the distal end of this elongate portion is at the top or start of the pressure chamber 42, conduit and/or channel 44. In this example design, this elongate portion 56 of the upper electrode 14 is centered laterally (e.g., in the X direction) with respect to the pressure chamber 42, conduit and/or channel 44 and the sidewalls 50 thereof. The lower electrode 16 is at the bottom or end of the pressure chamber 42, conduit and/or channel 44. As discussed above, in this example, the bottom electrode 16 includes the orifice 30 therein through which droplets of liquid metal are output. In this example design, this orifice 30 is centered laterally (e.g., in the X direction) with respect the pressure chamber 42, conduit and/or channel 44 and the sidewalls 50 thereof. Accordingly, in this design, the pressure chamber 42, conduit and/or channel 44 extends from the first (upper or top) electrode 14 to the second (lower or bottom) electrode 16.

As illustrated, the second, lower, or bottom electrode 16 comprises a conductive (e.g., planar) surface or layer having the orifice 30 therein at a distal end of the pressure chamber 42, conduit and/or channel 44. In some implementations, the second, lower, or bottom electrode 16 comprises a nozzle with the orifice 30 at a distal end thereof. The second electrode 16, however, may have a variety of shape and the orifice 30 may have other locations or configurations. As discussed above, the orifice 30 is at one end of the channel 52 such that the liquid metal flows therethrough when sufficient internal pressure is applied to the liquid metal. Liquid metal drops are thereby formed.

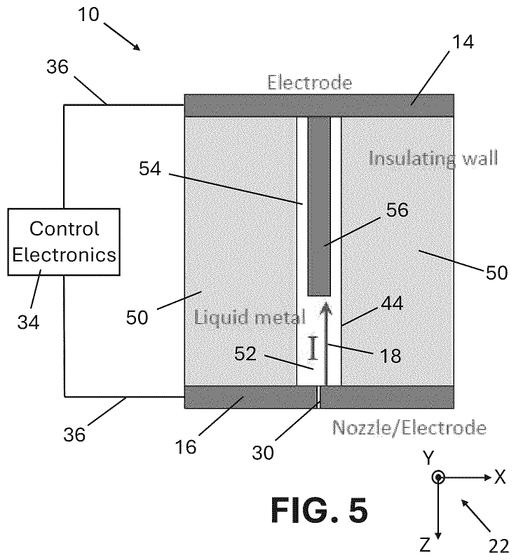

FIG. 5 shows another system 10 for liquid metal jetting comprising a pressure chamber 42 formed between sidewalls 50 providing a channel 44 for flow of liquid metal through an orifice 30 to form drops of liquid metal. The system 10 include first and second (e.g., upper and lower or top and bottom) electrodes 14, 16. Similar to the system 10 shown in FIG. 4A, the upper electrode 14 includes a conductive layer 55 and elongate conductive portion 56 extending therefrom and the lower electrode 16 comprises a layer having the orifice 30 therein. Sidewalls 50 form a region 54 therebetween. The elongate conductive portion 56 of the upper electrode 14 extends (e.g., in the Z direction) into this region 54 and to the pressure chamber 42, conduit, and/or channel 44 also formed between the sidewalls 50. In the example shown, the pressure chamber 42, conduit, and/or channel 44 may have the shape of a cylinder such as a right circular cylinder. The inner walls of the sidewalls 50 may likewise have a shape of a cylinder such as a right circular cylinder.

As shown, electronics 34 such as a power supply (e.g., current and/or voltage supply) may be electrically connected to the first and second electrodes 14, 16 via one or more cables, leads or conductive lines 36, etc. The electronics 34 may be configured to provide a current 18 between the electrodes 14, 16. In particular, in various implementations, the electronics 34 are configured to provide a current pulse along the length of the liquid metal within the pressure chamber 42, conduit and/or channel 44 between the electrodes 14, 16. The current pulses flowing through the liquid metal induce a time varying magnetic field B, 24 pursuant to Ampere's law. This magnetic field, B, 24, causes a radially inward forces 26 and pressure to be applied on the length of liquid metal due to interaction between the induced magnetic field and the current 18, e.g., pursuant to Lorentz's law. The radially inward directed Lorentz forces 26 compress the region 20 of liquid metal in the pressure chamber 44 through which the current 18 flows and/or is concentrated. These radially inwardly directed compressive forces 26 within the channel 44 of the pressure chamber 44 produced a longitudinally directed pressure, P, 28 (e.g., in the Z direction). This longitudinally directed pressure, P, 28 is sufficient to cause metal to flow through the orifice 30 such that liquid metal droplets are output therefrom.

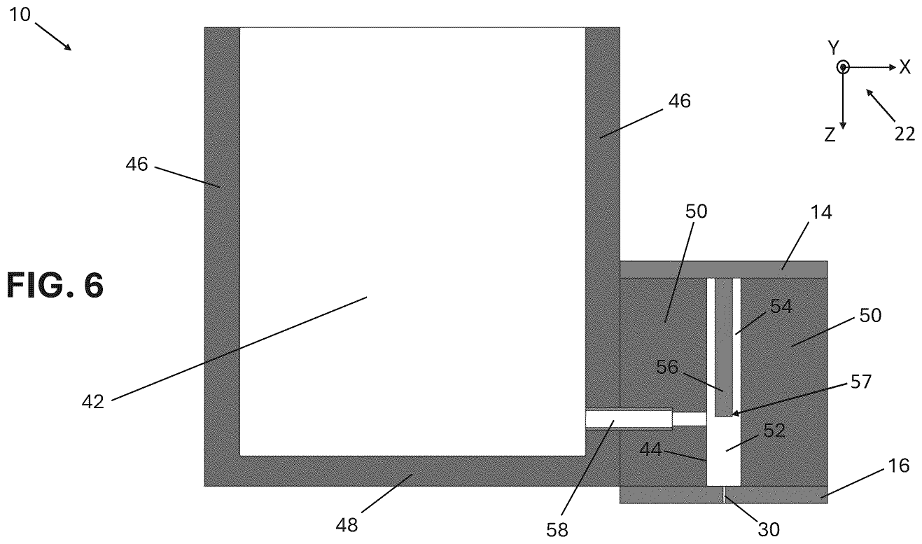

A wide variety of configurations of the system or apparatus 10 for additive manufacturing using liquid metal are possible. FIG. 6, for example, shows configuration similar to that shown in FIG. 4A with the reservoir 42 on one side as opposed to over the pressure chamber 44. The reservoir 42 is nevertheless in fluid communication with the pressure chamber 44. In the example shown, a pathway is provided from for liquid metal to flow from the reservoir 42 to the pressure chamber 44. In particular, a hole or opening in the sidewalls 46 and a hole in the side wall 50 of the conduit form a pathway or line (e.g., fill line) 58 for liquid metal to flow from the reservoir 42 to the pressure chamber. The fill line 58 has an outlet towards the top of the pressure chamber 44, conduit and/or channel 52 and closer to the first electrode 14 than the second electrode 16. Additionally, the fill line 58 and the outlet thereof is closer to the distal end of the elongate portion 56 of the first electrode 14 than the proximal end of the elongate portion of the first electrode or the planar layer or portion 55 of the first electrode. Accordingly, in various designs, one or more fill lines 58 provides a path for the liquid metal to flow from the reservoir 42 to said pressure chamber 44. For example, a pathway or fill line 58 comprising a hollow region in an insulating wall 46, 50 may be provided. This pathway or fill line 58 may be sufficiently wide for the liquid metal to flow from the reservoir 42 to the pressure chamber 44, conduit, and/or channel 52 therein.

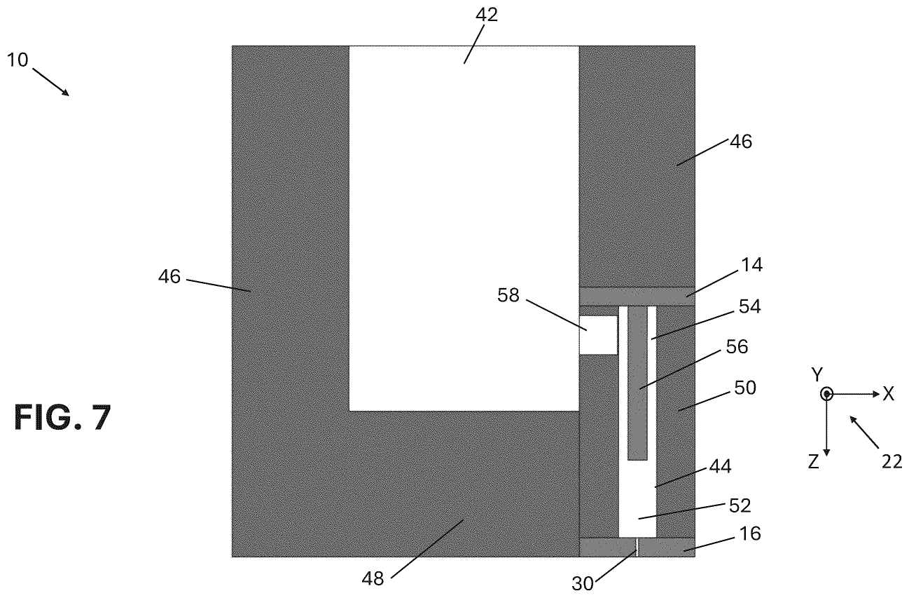

FIG. 7 is an example of another system 10 similar to that shown in FIG. 6 with the reservoir 42 off to the side as opposed to over the pressure chamber 44. Similarly, the reservoir 42 is in fluid communication with the pressure chamber 44, via a pathway 58 provided for liquid metal to flow from the reservoir 42 to the pressure chamber 44. As shown, a hole or opening in the side wall 50 of the conduit form a pathway or line (e.g., fill line) 58 for liquid metal to flow from the reservoir 42 to the pressure chamber 44. The fill line 58 has an outlet closer to the first electrode 14 than the second electrode 16. However, in this example, the fill line 58 and the outlet thereof is closer to the proximal end of the elongate portion 56 of the first electrode 14 or the planar layer or portion 55 of the first electrode than the distal end of the elongate portion of the first electrode. The fill line 58 has an outlet that is coupled to the region 54 between the sidewalls 50 above the distal end of the upper electrode 14. Likewise, the fill line 58 has an outlet that is coupled to the region 54 between the sidewalls 50 above the pressure chamber 44, the conduit, and/or the channel 52 therein.

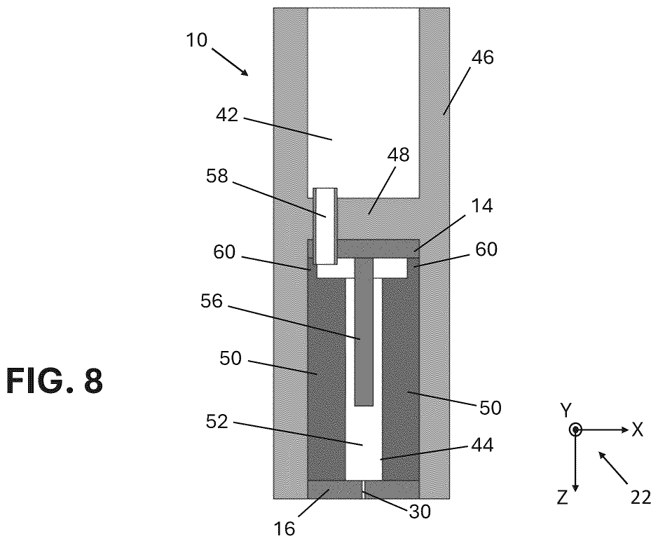

FIG. 8 is an example of another system 10 similar to those shown in FIGS. 6 and 7, however, with the reservoir 42 over the pressure chamber 44. Similarly, the reservoir 42 is in fluid communication with the pressure chamber 44, via a pathway provided for liquid metal to flow from the reservoir 42 to the pressure chamber 44. As shown, a hole or opening in the floor 48 of the reservoir 42 provides a pathway or line (e.g., fill line) 58 for liquid metal to flow from the reservoir to the pressure chamber 44. This pathway or fill line 58 also passes through a portion of the first (e.g., top or upper) electrode 14, for example, through the planar portion 55 of the first electrode. In the example shown in FIG. 8, the pathway or line 58 comprises a hollow tube that passes through the hole or opening in the floor 48 of the reservoir 42 and a portion of the first electrode 14. Recessed portions 60 of the side wall 50 provide open areas for the liquid metal to flow from the pathway or line 58 into the open region 54 and down to the pressure chamber 44, conduit, and/or channel 52 therein.

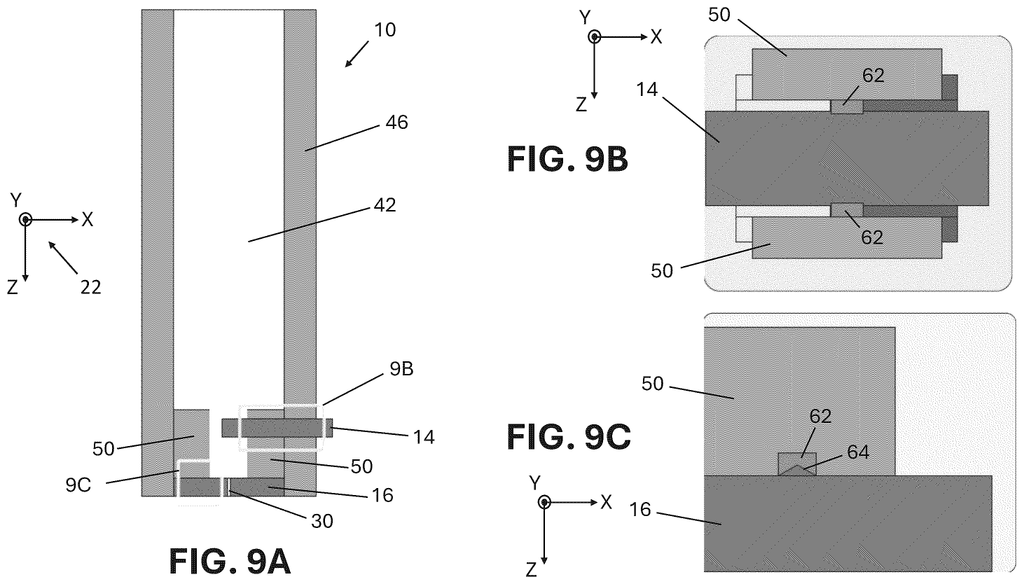

FIG. 9A shows an example of another system 10 similar to that shown in FIG. 8 with a reservoir 42 over the pressure chamber 44, however, the first (e.g., upper or top) electrode 14 extends in from one side, through a sidewall 50. The first, upper or top electrode 14 comprises an elongate electrode having a distal end at the top of the pressure chamber 42, conduit, and/or channel 52. As discussed above, a current 18 may flow through the liquid metal in the pressure chamber 42 between the first and second electrodes 14, 16. As shown, the second electrode 16 includes an orifice 30 therein through which liquid metal from within the pressure chamber 44 is ejected by the pressure induced by the compressive Lorentz forces 26 resulting from the magnetic field 24 created by the current 18 flowing between the electrodes 14, 16.

As illustrated in FIGS. 9B and 9C, gaskets or o-rings 62 may be employed to provide for seals and to reduce the likelihood of leakage of liquid metal from the apparatus 10. FIG. 9B shows a gasket 62 such as a metal gasket (e.g., copper) used to provide an effective seal on the top and bottom of the first electrode 14. FIG. 9C shows a gasket 62 such as a metal gasket (e.g., copper) used to provide an effective seal on the bottom electrode 16. A ridge or protrusion (e.g., knife-edge) 64 may be included, for example, in the electrode 16 and/or the side wall 50 to mate with the gasket or o-ring 62.

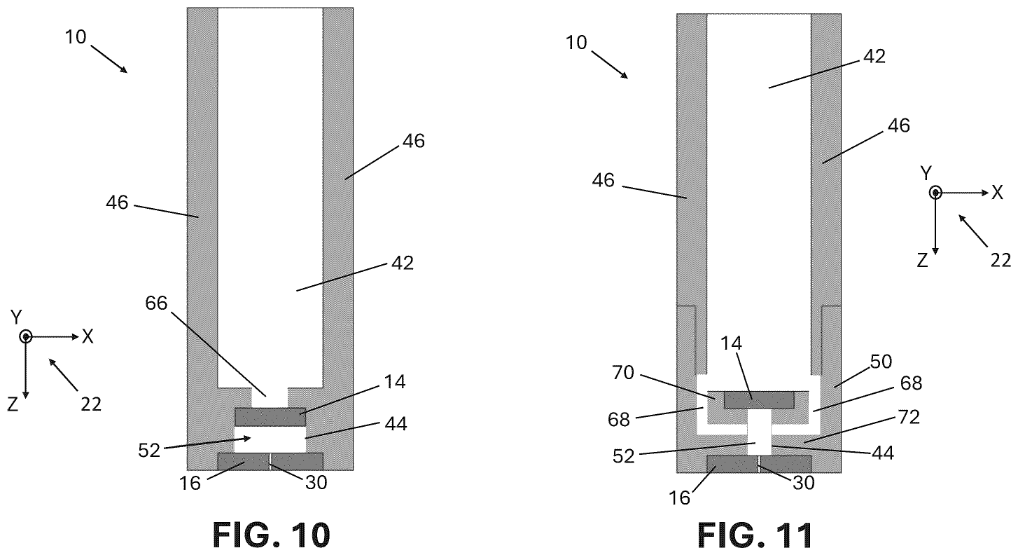

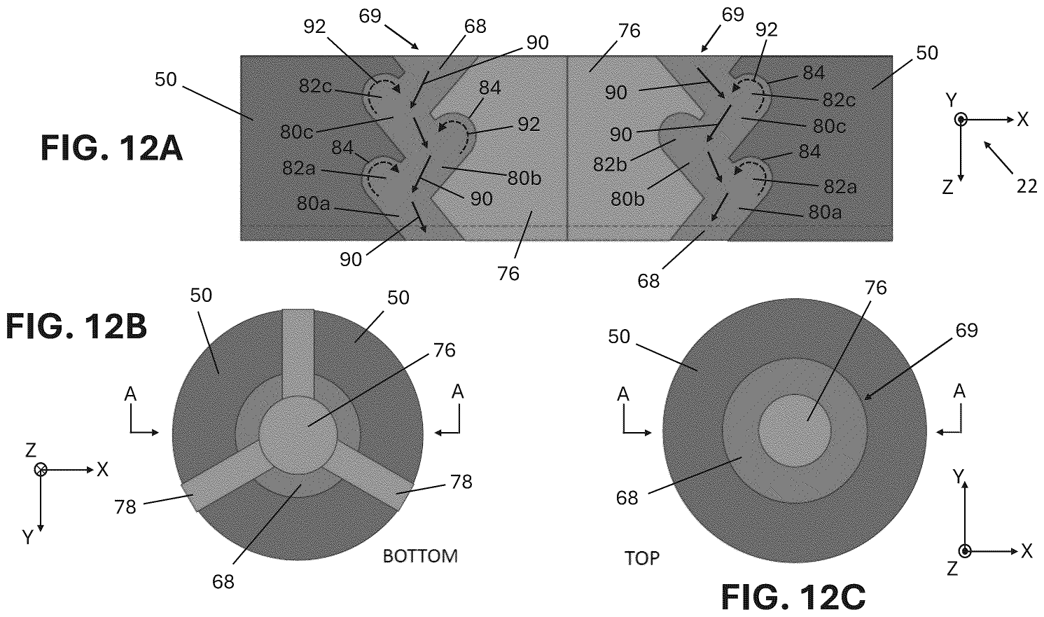

FIG. 10 shows an example of another system 10 with a reservoir 42 over the pressure chamber 44, however, the top electrode 14 includes a fill valve or flow valve comprising a hole (not shown) in the electrode for the liquid metal to flow through from the reservoir into the pressure chamber. In some implementations, this flow valve or fill valve may be similar to that shown in FIGS. 12A-12C. Nevertheless, in various implementations, the fill valve comprises a passive flow valve given the harsh environment (e.g., high temperature and potentially high reactivity). The apparatus 10 includes a neck 66 formed by the inner walls of the sidewalls 46 forming an open region therebetween that is narrower than the width of the open region for liquid metal in the remainder of the reservoir above. The first electrode 14 with the hole or valve therein is below. The pressure chamber 44 and associated channel 52 is below the first electrode 14, between the first and second electrodes 14, 16.

FIG. 11 an example of another system 10 with a reservoir 42 over the pressure chamber 44, further comprising a plurality of fill lines 68 on opposite sides of the top electrode 14 used to supply liquid metal to the pressure chamber 44. As illustrated, the fill lines 68 feed into the pressure chamber 44, conduit, and/or channel 52 from opposite sides in the example shown. These fill lines 68 also fill into the pressure chamber 44 on sides between the first and second electrodes 14, 16. The fill lines 68 may be formed at least in part by indentations in the side walls 50 as well as some insulating material 70 on the first electrode 14, e.g., on the edges and/or underneath thereof. The side wall 50 also includes ledges 72 that cover portions of the second (lower or bottom electrode) 16. These ledges 72 of the side wall 50 as well as the insulating material 70 (e.g., on the sides, edges, and/or underside of the first electrode 14) provide for a more narrow and potentially elongated pressure chamber 44 and channel 52 therein. As illustrated, the second electrode 16 includes an orifice 30 therein beneath the pressure chamber 44 for the liquid metal to flow through to form liquid metal droplets.

Fill lines 68 like those shown in FIG. 11 also for flowing liquid metal from the reservoir 42 into the pressure chamber 44 may comprise a valve 69, e.g., a flow valve or fill valve, configured to reduce flow of liquid metal in the reverse direction, e.g., from the pressure chamber into the reservoir. FIG. 12A is a cross-sectional view of example valve such as a flow valve or fill valve 69 used to flow liquid metal from the reservoir 42 to the pressure chamber 44. This valve 69, however, is configured to reduce backflow. This valve 69, for example, has a shape configured to reduce flow of liquid metal from the pressure chamber 44 to the reservoir 42. The contours, e.g., irregular contouring, on the walls of the fill valve 69 allows flow in the forward (+Z) direction while inhibiting flow in the reverse direction (−Z).

The valve 69 is formed by regions between (i) sidewalls 46, 50, for example, of the reservoir 42, or pressure chamber 44, or other structure (e.g., a conduit), and (ii) a medial component or insert 76. The insert is a separate part from the sidewalls 46, 50 of the reservoir 42 or pressure chamber 44. Once mated, the outer contour of the insert and the inner contour of the sidewalls of the reservoir 42 and/or pressure chamber 44 create a “negative space” or “open space” that operates as the valved flow region or channel 68 for the liquid metal.

The insert 76, for example, has a smaller lateral dimension, e.g., width, (e.g., in the X direction) than the lateral distance, e.g., width, separating opposing sidewalls 46, 50 of the outer structure. Both the side surface of the medial component or insert 76 as well as the inner walls of the sidewalls 46, 50 are contoured to configure the shape of the valve 69 (e.g., the shape of the sidewalls of the valve). This shape, for example, is configured to provide for flow of liquid metal in one direction (e.g., +Z in FIG. 12A) and inhibit flow in the opposite direction (e.g., −Z in FIG. 12A).

As shown, the valve 69 comprises elongate segments 80a-80c that are alternately directed at different angles, for example, +θ° and −θ° (e.g., +20° and −20° or +30° and −30° with respect the Z direction). These elongate segments 80a-80c form a “zig-zag” pattern and/or “zig-zag”, for example, in cross-section. For example, the cross-section presented in FIG. 12A depicts this zig-zag pattern. These elongate segments 80a-80c are alternately directed in different oppositely directed directions. The segments 80a-80c (at least the cross-section thereof) are shown alternately pointing back and forth to different directions on opposite sides of an axis such as the longitudinal direction (Z direction) or other axis or direction. The directions are not limited to +20° and −20° or +30° and −30°. The directions may be within ±1°, ±2°, ±3°, ±4°, ±5°, ±6°, ±8°, ±9°, ±10°, ±12°, ±15°, ±18°, ±20°, ±24°, ±25°, ±28°, ±30°, ±32°, ±35°, ±38°, ±40°, ±45°, ±50°, ±55°, ±60°, ±65°, ±70°, ±75°, ±80°, ±85°, ±89°, ±90° with respect to the longitudinal direction or axis (e.g., Z direction) or another axis or direction or in any range formed by any of these values or possibly larger or smaller angles. The directions, however, need not be symmetric, for example, about the longitudinal (Z) direction, but can be asymmetric. For example, a first group of segments can be directed at an angle of +30° while a second group of segments can be directed at an angle of −20°, with segments from the first group alternating with segments from the second groups to produce the plurality of segments that are alternately pointing back and forth (e.g., zig-zag in cross-section) to different directions on opposite sides of an axis such as the longitudinal direction (Z direction) or other axis or direction.

The elongate segments 80a-80c are jointed together at joints to form a continuous path. Arrows 90 show this path. The arrows 90 are directed toward the +Z direction or other axis. Liquid metal, for example, may flow along this path, for example, from the reservoir 42 to the pressure chamber 44.

The elongate segments 80a-80c include extensions 82a-82c located beyond the joints where the segments join. The extensions 82a-82c do not continue on (e.g., onto another segment 80a-80c) but are terminated. In the example shown, the extensions 82a-82c have curved shapes such that, as with a cul-de-sac, the liquid metal can flow into the extension in one direction and back out of the extension in an opposite direction. In some designs, the extensions 82a-82c comprise a curved possibly arc-shaped sidewall having a center or otherwise disposed about a rotation axis such that the liquid metal flowing into the extension rotates about this axis and returns out of the extension in the opposite direction in which the liquid metal entered the extension. Likewise, at least a portion of the liquid metal flowing in the opposite direction (e.g., in the −Z direction or in the opposite direction along another axis) as the arrows 90 will proceed along one or more segments 80a-80c and into one or more of these extensions 82a-82c. The extensions 82a-82c, however, will not lead to another segment 80a-80c.

Moreover, the extensions 82a-82c have surfaces 84 contour and have dimensions to redirect the flow back out of the extension in the opposite direction from which it entered the extension as illustrated by a curved arrow (dotted arrow) 92. Likewise, a portion of the liquid metal flowing in the reverse direction, for example, from the pressure chamber 44 to the reservoir 42 (e.g., in the −Z direction or close thereto) will enter the extensions 82a-82c and be redirected by the contoured surfaces 84 backward out of the extensions in the opposite direction from which it entered the extensions. This returned liquid metal, will flow against the liquid metal going in the reverse direction, e.g., from the pressure chamber 44 to the reservoir 42. This configuration will therefore impede backflow of liquid metal from the pressure chamber 44 into the reservoir 42. As illustrated, this contoured surface 84 may be curved and may be concave. In some designs such as shown, the contoured surface 84 may have a cross-section comprising a circularly shaped curve.

FIG. 12A is a cross-section of the sidewalls 50, flow line(s) 68, and the medial component or insert 76. FIGS. 12B and 12C are schematic bottom and top views of the contoured valve(s) 69 depicted in FIG. 12A. FIG. 12A, for example, is a cross-section through the line A-A shown in FIGS. 12B and 12C. FIGS. 12B and 12C show the sidewalls 50 disposed about the medial component or insert 76. A space between the inner wall of the sidewalls 50 and the outer wall or surface of the medial component or insert 76 form gaps or open regions through which the liquid metal may flow. This gap or open region is the flow line(s) 68. FIG. 12B additionally shows supports 78 holding the medial component or insert 76 in position between the sidewalls 50. The supports 78 are configured to situate the medial component or insert 76 in position between the sidewalls 50 so as to provide for the gap or open region 68 between the medial component or insert and the sidewalls to provide the flow valve(s) 69 for flow of liquid metal. As discussed above, the sidewalls 50 and the medial component or insert 76, for example, the walls of the sidewalls 50 and/or the outer surface of the medial component or insert can have contours or contouring to facilitate the flow of liquid metal in one direction (e.g., the +Z direction) and inhibit flow in the opposite direction (e.g., −Z direction). Consequently, the flow line(s) 68 may be configured to provide for flow from the reservoir 42 to the pressure chamber 44 but to inhibit flow in the reverse direction from the pressure chamber to the reservoir.

In various designs, the dimensions of the fill line(s) 68 and/or other components of the system 10 may be small. The induced ZMHD pressure is inversely proportional to the square of the radius, R, of the liquid metal column, determined by the inner diameter or lateral width of the pressure chamber 44. Additionally, given the material properties of a low-T liquid metal like gallium, a pressure chamber 44 may be approximately 1 mm in diameter or width (e.g., in the X direction) in some implementations. However, the width in the lateral direction (e.g., in the X direction) or diameter (e.g., 2R) of the pressure chamber 44, channel 52, and/or region of liquid metal 20 where current 18 is concentrated may be 0.1 millimeters (mm), 0.2 mm, 0.3 mm, 0.4 mm, 0.5 mm, 0.6 mm, 0.8 mm, 1.0 mm, 1.2 mm, 1.4 mm, 1.5 mm, 1.6 mm, 1.8 mm, 2.0 mm, 1.2 mm, 1.5 mm, 1.8 mm, 2.0 mm, 2.2 mm, 2.5 mm, 2.8 mm, 3.0 mm, 3.5 mm, 4.0 mm, 4.5 mm, 5.0 mm or any range formed by any of these values or possibly larger or smaller. The height, h, is less important to the direct ZMHD pressure, but the height can impact the magnitude of Joule-heating-based thermal expansion that may alter the fluid dynamics of the pressure chamber 44. Heights, h, of approximately 10 mm should be achievable through fabrication and workable through practice of the ZMHD actuation mechanism. However, the height or length or longitudinal extent in the longitudinal direction (e.g., in the Z direction) of the pressure chamber 44, channel 42, region of liquid metal 20 where current 18 is concentrated, and/or separation between first and second electrodes 14, 16 may be 2 mm, 3 mm, 4 mm, 5 mm, 6 mm, 8 mm, 10 mm, 12 mm, 14 mm, 15 mm, 16 mm, 18 mm, 20 mm, 22 mm, 25 mm, 28 mm, 30 mm, 35 mm, 40 mm, 45 mm, 50 mm or any range formed by any of these values or possibly larger or smaller.

The orifice size may affect droplet ejection. An orifice 30 that is too large may not be able to prevent gravity-fed draining of the reservoir 42. An orifice 30 that is too small may involve higher pressures (and thus smaller pressure chambers 44) to actuate. The orifice 30 may, for example, have a width (e.g., diameter) in the lateral direction (e.g., X and/or Y direction) that is 0.01 mm, 0.02 mm, 0.03 mm, 0.04 mm, 0.05 mm, 0.06 mm, 0.07 mm, 0.08 mm, 0.09 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.5 mm, 5.0 mm or any range between any of these values or possibly larger or smaller sizes.

The device operates by filling the pressure chamber 44 with a liquid metal and then pulsing a high current (of order 100 amps) through the pressure chamber in approximately 0.5 ms. This timing is compatible with the fluid properties of liquid metals (e.g., surface tension, viscosity, density, etc.) to create droplets with orifices 30 in the size range of 0.05-1 mm.

The current pulses may, for example, have a current of 50 A, 75 A, 100 A, 125 A, 150 A, 200 A, 225 A, 250 A, 275 A, 325 A, 300 A, 350 A, 375 A, 400 A, 425 A, 450 A, 475 A, 500 A, 525 A, 550 A, 575 A, 600 A, 650 A, 700 A, 750 A, 800 A, 850 A, 900 A, 950 A, 1000 A, 1200 A, 1400 A, 1500 A, 1600 A, 1800 A, 2000 A, 2500 A, 3000 A, 3500 A, 4000 A, 4500 A, 5000 A or any range formed by any of these values or possible larger or smaller.

The current pulses may, for example, have a duration (e.g., temporal pulse width at full width half maximum) of 0.01 ms, 0.02 ms, 0.05 ms, 0.08 ms, 0.1 ms, 0.2 ms, 0.3 ms, 0.4 ms, 0.5 ms, 0.6 ms, 0.8 ms, 0.9 ms, 1.0 ms, 1.2 ms, 1.4 ms, 1.5 ms, 1.6 ms, 1.8 ms, 2.0 ms, 2.5 ms, 3.0 ms, 3.5 ms, 4.0 ms, 4.5 ms, 5.0 ms, 5.5 ms, 6.0 ms, 6.5 ms, 7.0 ms, 7.5 ms, 8.0 ms, 8.5 ms, 9.0 ms, 9.5 ms, 10.0 ms, 12 ms, 14 ms, 15 ms, 20 ms, 30 ms, 40 ms, 50 ms or any range formed by any of these values or possible longer or shorter.

The droplets 30 may, for example, have a width (e.g., diameter) in the lateral direction (e.g., X and/or Y direction) that is 0.01 mm, 0.02 mm, 0.03 mm, 0.04 mm, 0.05 mm, 0.06 mm, 0.07 mm, 0.08 mm, 0.09 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.5 mm, 5.0 mm or any range between any of these values or possibly larger or smaller sizes. In some cases, the droplets have a width (e.g., diameter, D) that is 1-5 times, 1-3 times, 1.5-5 times, 1.5-3 times, e.g., 2 times, the width (e.g., diameter, D) of the orifice 30.

The current 18 can be pulsed with commercial-off-the-shelf high-current-capacity electronic equipment. Droplets are ejected from the orifice 30 with respective pulses, and those droplets may be on order the orifice size in diameter.

Advantageously, in various designs disclosed herein the formation of a liquid metal droplet is produced more by the magnetic field induced by the current pulse through said liquid metal than by a permanent magnet. Or at least the formation of a liquid metal droplet is produced more by the magnetic field induced by said current pulse through said liquid metal than by a permanent magnet having a magnetic field of 0.5 Tesla (T), 0.8 T, 1 T, 1.2 T, 1.5 T or more.

Additionally, advantageously in various designs disclosed herein the formation of a liquid metal droplet from the liquid metal flowing through the orifice is produced more by the magnetic field induced by the current pulse through the liquid metal than by current through a conductive coil. Or at least the formation of a liquid metal droplet from the liquid metal flowing through the orifice is produced more by the magnetic field induced by the current pulse through the liquid metal than by current through a conductive coil that produces at least one milliTesla (mT), 5 mT, 10 mT. 15 mT, 20 mT or any range formed by any of these values (e.g., from 1 mT to 10 mT).

A wide range of variations in the systems 10 and methods described herein are possible. For example, the bottom electrode 16 need not be a plate or layer with a hole 30 therein. In some designs, for example, the bottom electrode 16 comprises a metal ring with orifice hole 30 therein. Similarly, in certain implementations, either the top or bottom electrode 14, 16 may comprise a wire electrode. In some designs, for example, a wire of sufficient size (e.g., cross-sectional diameter), for example, to carry the large currents to provide sufficient squeezing pressure via Lorentz forces may be used. The wire may also be of sufficient size (e.g., cross-sectional diameter) to provide adequate wetting of the liquid metal given the surface tension of the liquid metal so as to thereby reduce the likelihood of arcing and make effective electrical contact with the liquid metal. Other variations are possible.

### Examples

This disclosure provides various examples of devices, systems, and methods. Some such examples include but are not limited to the following examples.

### Part I:

1. An apparatus for additive manufacturing using liquid metal, said apparatus comprising:
a pressure chamber comprising a channel for liquid metal such that a length of liquid metal is within said channel;
an orifice at one end of said channel such that said liquid metal flows therethrough when sufficient internal pressure is applied to the liquid metal;
first and second electrodes arranged with respect to channel to direct a current to flow along said length of said liquid metal in said channel between said first and second electrodes; and
electronics electrically connected to said electrodes to provide a current pulse along the length of said liquid metal, said current through said liquid metal inducing a magnetic field which causes radially inward directed forces to be applied on the length of liquid metal due to interaction between the induced magnetic field and said current,
wherein said radially inward directed forces are sufficient to cause metal to flow through said orifice.

2. The apparatus of Example 1, wherein said pressure chamber comprises a conduit comprising insulating walls forming said channel therebetween.

3. The apparatus of Example 2 or 3, wherein said pressure chamber is included in said conduit.

4. The apparatus of Example 2 or 3, wherein said first electrode extends into said conduit.

5. The apparatus of any of the examples above, wherein said first electrode comprises an elongate conductor.

6. The apparatus of any of the examples above, wherein said second electrode comprises said orifice therein.

7. The apparatus of any of the examples above, wherein said second electrode comprises a nozzle with said orifice therein.

8. The apparatus of any of the examples above, wherein said pressure chamber extends from said first electrode to said second electrode.

9. The apparatus of any of the examples above, wherein said channel has a width in the lateral direction that is from 0.1 to 3 mm.

10. The apparatus of any of the examples above, wherein said channel has a width in the lateral direction that is about 1 mm.

11. The apparatus of any of the examples above, wherein said channel has a length from said first electrode to said second electrode of from 1 mm to 40 mm.

12. The apparatus of any of the examples above, wherein said channel has an length from said first electrode to said second electrode that is about 10 mm.

13. The apparatus of any of the examples above, wherein said orifice has a width in the lateral direction of between about 0.05 to 3 mm.

14. The apparatus of any of the examples above, wherein said electronics are configured to provide a current pulse having a current of from 50 to 2000 Amps.

15. The apparatus of any of the examples above, wherein said electronics are configured to provide a current pulse having a current of from 80 to 200 Amps.

16. The apparatus of any of the examples above, wherein said electronics are configured to provide a current pulse having a pulse duration of 0.1 ms to 10 ms.

17. The apparatus of any of the examples above, wherein said electronics are configured to provide a current pulse having a pulse duration of 0.5 ms.

18. The apparatus of any of the examples above, further comprising a reservoir for liquid metal in fluid communication with said elongate pressure chamber.

19. The apparatus of Example 18, further comprising at least one fill line providing a path for said liquid metal from said reservoir to said pressure chamber.

20. The apparatus of Example 19, wherein said fill line comprises a hollow region in an insulating wall sufficiently wide for said liquid metal to flow.

21. The apparatus of Example 19 or 20, wherein said at least one fill line comprises a fill valve configured such that liquid metal can flow in a first direction from said reservoir to said pressure chamber, while liquid metal flow in a second reverse direction from said pressure chamber to said reservoir is reduced by said at least one fill line.

22. The apparatus of Example 21, wherein said fill valve comprises a plurality of segments that zig-zag back and forth.

23. The apparatus of any of Examples 22, wherein said plurality of segments are joined together at joints to form a continuous path through which said liquid metal can flow.

24. The apparatus of Example 23, further comprising extensions located beyond said joints.

25. The apparatus of Example 24, wherein said extensions are terminated such the liquid metal that flows in said extension is forced to return back to said joint.

26. The apparatus of Example 24 or 25, wherein said extensions have shapes configured to cause liquid metal that flows into said extension to return back to said joint.

27. The apparatus of any of Examples 24-26, wherein said extensions have curved shapes configured to cause liquid metal that flows into said extension to return back to said joint.

28. The apparatus of any of Examples 18-27, wherein said reservoir is disposed with respect to said pressure chamber such that said liquid metal is gravity feed from said reservoir into said pressure chamber.

29. The apparatus of any of Examples 18-28, further comprising a pressure source configured to be applied to said liquid metal in said reservoir to feed liquid metal from said reservoir into said pressure chamber.

30. The apparatus of any of Examples 18-29, wherein said top electrode comprises an elongate conductor within said reservoir.

31. The apparatus of Example 30, wherein said elongate conductor has a point within a proximal end of said pressure chamber.

32. The apparatus of any of the examples above, further comprising a heater configured to maintain liquid metal in liquid state.

33. The apparatus of any of the examples above, wherein said bottom electrode comprises a conductive surface having said orifice therein at a distal end of said channel.

34. The apparatus of any of the examples above, wherein said orifice outputs liquid metal droplets having a size between 0.05 to 1.0 mm.

35. The apparatus of any of the examples above, wherein said first and second electrodes are position with respect to each other and the orifice such that said orifice is downstream of pressure induced in said liquid metal when current is flowed between said first and second electrodes.

36. The apparatus of any of the examples above, wherein said first and second electrodes comprise upper and lower electrodes, respectively, with the first upper electrode position above said second lower electrode.

37. The apparatus of Example 36, wherein said first upper electrode is above the orifice.

38. The apparatus of Example 36 or 37, wherein said orifice is coincident or beneath the lower electrode.

39. The apparatus of any of the examples above, wherein said first and second electrodes are separated from each other in a longitudinal direction to provide a current in said longitudinal direction through said liquid metal, and wherein liquid metal is ejected through said orifice in said longitudinal direction.

40. The apparatus of any of the examples above, wherein said first and second electrodes are separated from each other in a longitudinal direction, and wherein said pressure chamber comprises an elongate orifice having a length or height in a longitudinal direction greater than width in a lateral direction.

41. The apparatus of any of the examples above, wherein said apparatus provides said magnetic field which causes radially inward directed forces to be applied on the length of liquid metal and causes said metal to flow through said orifice primarily from said current through said liquid metal.

42. The apparatus of any of the examples above, wherein said magnetic field produced by said current through said liquid metal contributes more to radially inward directed forces that cause metal to flow through said orifice than any permanent magnet.

43. The apparatus of any of the examples above, wherein said apparatus does not employ a permanent magnet to provide a magnetic field that forces said metal to flow through said orifice.

44. The apparatus of any of the examples above, wherein said magnetic field produced by said current through said liquid metal contributes more to radially inward directed forces that cause metal to flow through said orifice than any conductive coil.

45. The apparatus of any of the examples above, wherein said apparatus does not employ a conductive coil to provide said magnetic field that forces said metal to flow through said orifice.

46. The apparatus of any of the examples above, wherein a drop of liquid metal is formed by said liquid metal flowing through said orifice as a result of a pulse of current between said first and second electrodes.

47. The apparatus of any of the examples above, wherein formation of a liquid metal droplet is induced primarily by said magnetic field caused by said current pulse through said liquid metal.

48. The apparatus of any of the examples above, wherein formation of a liquid metal droplet is produced more by said magnetic field induced by said current pulse through said liquid metal than by a permanent magnet.

49. The apparatus of any of the examples above, wherein formation of a liquid metal droplet is produced more by said magnetic field induced by said current pulse through said liquid metal than by a permanent magnet of at least 0.8 Tesla.

50. The apparatus of any of the examples above, wherein formation of a liquid metal droplet from said liquid metal flowing through said orifice is produced more by said magnetic field induced by said current pulse through said liquid metal than by current through a conductive coil.

51. The apparatus of any of the claims above, wherein formation of a liquid metal droplet from said liquid metal flowing through said orifice is produced more by said magnetic field induced by said current pulse through said liquid metal than by current through a conductive coil that produces at least one milliTesla.

### Part II

1. An apparatus for additive manufacturing using liquid metal, said apparatus comprising:
a pressure chamber including a channel therein for liquid metal;
a reservoir for liquid metal in fluid communication with said elongate pressure chamber;
at least one fill line providing a path for said liquid metal to flow from said reservoir to said pressure chamber; and
an orifice at one end of said channel such that said liquid metal flows therethrough when sufficient internal pressure is applied to the liquid metal,
wherein said at least one fill line comprises at least one valve configured such that liquid metal can flow in a first direction from said reservoir to said pressure chamber, while liquid metal flow in a second reverse direction from said pressure chamber to said reservoir is reduced by said at least one valve.

2. The apparatus of Example 1, wherein said at least one valve has sidewalls and said side walls are configured such that liquid metal can flow in a first direction from said reservoir to said pressure chamber, while liquid metal flow in a second reverse direction from said pressure chamber to said reservoir is reduced.

3. The apparatus of Example 1 or 2, wherein said at least one valve has sidewalls with irregular contours that reduce liquid metal flow in a reverse direction from said pressure chamber to said reservoir.

4. The apparatus of any of the examples above, wherein said at least one valve comprises a gap between inner walls of sidewalls of a conduit and a medial component inserted between said sidewalls.

5. The apparatus of Example 4, further comprising supports configured to hold said medial component between said sidewall such that a gap exists between said medial component and said sidewalls, said gap forming in said at least one valve.

6. The apparatus of Example 4 or 5, wherein inner walls of said side walls and outer surfaces of said medial component are configured such that liquid metal can flow in a first direction from said reservoir to said pressure chamber, while liquid metal flow in a second reverse direction from said pressure chamber to said reservoir is reduced.

7. The apparatus of any of Examples 4-6, wherein inner walls of said side walls and outer surfaces of said medial component have irregular contours that reduce flow of liquid metal in a reverse direction from said pressure chamber to said reservoir.

8. The apparatus of any of the examples above, wherein said at least one valve comprises a plurality of elongate segments that are alternately directed back and forth at different directed angles.

9. The apparatus of any of the examples above, wherein said valve comprises a plurality of elongate segments that point back and forth along different directions on opposite sides of a longitudinal (Z) direction, wherein said different directions are within a range of angles of at least ±10° and as much as ±45° with respect to said longitudinal direction.

10. The apparatus of Example 9, wherein liquid metal is ejected from said orifice in said longitudinal (Z) direction.

11. The apparatus of Example 9 or 10, wherein pressure chamber is separated from said reservoir in said longitudinal (Z) direction.

12. The apparatus of any of the examples above, wherein said valve comprises a plurality of segments that zig-zag back and forth.

13. The apparatus of any of Examples 8-12, wherein said plurality of segments are joined together at joints to form a continuous path through which said liquid metal can flow.

14. The apparatus of Example 13, further comprising extensions located beyond said joints.

15. The apparatus of Example 14, wherein said extensions are terminated such that liquid metal that flows in said extension is forced to return back to said joint.

16. The apparatus of Examples 14 or 15, wherein said extensions have shapes configured to cause liquid metal that flows into said extension to return back to said joint.

17. The apparatus of any of Examples 14-16, wherein said extensions have curved shapes configured to cause liquid metal that flows into said extension to return back to said joint.

18. The apparatus of any of Examples 14-17, wherein said extensions have concave curved shapes configured to cause liquid metal that flows into said extension to return back to said joint.

19. The apparatus of any of Examples 14-18, wherein said extensions have concave curved shapes having a circular cross-section.

### Part III

1. A valve configured for flowing liquid in a first direction, while inhibiting the flow of liquid in a second reverse direction, said valve comprising:
a channel for the flow of said fluid, said channel comprising a plurality of elongate segments that are alternately directed back and forth at different directed angles such that said liquid flows in said first direction along said channels, while liquid flow in said second reverse direction is reduced by said plurality of elongate segments.

2. The valve of any of the Example 1, wherein said plurality of elongate segments are directed back and forth along different directions on opposite sides of a longitudinal direction, wherein said different directions are within a range of angles of at least ±10° and as much as ±45° with respect to said longitudinal direction.

3. The valve of any of the examples above, wherein said plurality of elongate segments are oriented asymmetrically with respect to said longitudinal direction.

4. The valve of any of the examples above, wherein said plurality of segments that zig-zag back and forth.

5. The valve of any of the examples above, wherein said plurality of segments are joined together at joints to form a continuous path through which said liquid can flow.

6. The valve of Example 5, further comprising extensions located beyond said joints.

7. The valve of Example 6, wherein said extensions are terminated such that liquid metal that flows in said extension is forced to return back to said joint.

8. The valve of Examples 6 or 7, wherein said extensions have shapes configured to cause liquid that flows into said extension to return back to said joint.

9. The valve of any of Examples 6-8, wherein said extensions have curved shapes configured to cause liquid that flows into said extension to return back to said joint.

10. The valve of any of Examples 6-9, wherein said extensions have concave curved shapes configured to cause liquid that flows into said extension to return back to said joint.

11. The valve of any of Examples 6-10, wherein said extensions have concave curved shapes having a circular cross-section.

12. The valve of any of the claims above, further comprising:
a conduit having sidewall and an open inner region therebetween;
a medial component between but separated from said sidewalls so as to form a gap between inner walls of said sidewalls of said conduit and outer surfaces of said medial component for flow of said liquid.

13. The valve of Example 12, further comprising supports configured to hold said medial component between said sidewalls such that said gap exists between said medial component and said sidewalls.

14. The valve of Examples 12 or 13, wherein said inner walls of said sidewalls and outer surfaces of said medial component are configured such that liquid metal can flow in said first direction while liquid flow in said second reverse direction is reduced.

15. The valve of any of Examples 12-14, wherein said inner walls of said sidewalls and outer surfaces of said medial component have irregular contours that reduce flow of liquid in said second reverse direction.

Although the description above contains many details and specifics, these should not be construed as limiting the scope of the invention but as merely providing illustrations of some of the presently preferred embodiments of this invention. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present invention fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

What is claimed is:

1. An apparatus for additive manufacturing using liquid metal, said apparatus comprising:
a pressure chamber comprising a channel for liquid metal such that a length of liquid metal is within said channel;
an orifice at one end of said channel such that said liquid metal flows therethrough when sufficient internal pressure is applied to the liquid metal;
first and second electrodes arranged with respect to channel to direct a current to flow along said length of said liquid metal in said channel between said first and second electrodes; and
electronics electrically connected to said electrodes to provide a current pulse along the length of said liquid metal, said current through said liquid metal inducing a magnetic field which causes radially inward directed forces to be applied on the length of liquid metal due to interaction between the induced magnetic field and said current,
wherein said radially inward directed forces are sufficient to cause metal to flow through said orifice.

2. The apparatus of claim 1, wherein said pressure chamber comprises a conduit comprising insulating walls forming said channel therebetween.

3. The apparatus of claim 2, wherein said first electrode extends into said conduit.

4. The apparatus of claim 1, wherein said second electrode comprises said orifice therein.

5. The apparatus of claim 1, wherein said pressure chamber extends from said first electrode to said second electrode.

6. The apparatus of claim 1, wherein said channel has a width in the lateral direction that is from 0.1 to 3 mm.

7. The apparatus of claim 1, wherein said orifice has a width in the lateral direction of between about 0.05 to 3 mm.

8. The apparatus of claim 1, wherein said electronics are configured to provide a current pulse having a current of from 50 to 2000 Amps.

9. The apparatus of claim 1, wherein said electronics are configured to provide a current pulse having a pulse duration of 0.1 ms to 10 ms.

10. The apparatus of claim 1, further comprising a reservoir for liquid metal in fluid communication with said elongate pressure chamber.

11. The apparatus of claim 10, further comprising at least one fill line providing a path for said liquid metal from said reservoir to said pressure chamber.

12. The apparatus of claim 11, wherein said at least one fill line comprises a fill valve configured such that liquid metal can flow in a first direction from said reservoir to said pressure chamber, while liquid metal flow in a second reverse direction from said pressure chamber to said reservoir is reduced by said at least one fill line.

13. The apparatus of claim 10, wherein said reservoir is disposed with respect to said pressure chamber such that said liquid metal is gravity feed from said reservoir into said pressure chamber.

14. The apparatus of claim 10, further comprising a pressure source configured to be applied to said liquid metal in said reservoir to feed liquid metal from said reservoir into said pressure chamber.

15. The apparatus of claim 10, wherein said top electrode comprises an elongate conductor within said reservoir.

16. The apparatus of claim 1, wherein said orifice outputs liquid metal droplets having a size between 0.05 to 1.0 mm.

17. The apparatus of claim 1, wherein said first and second electrodes are separated from each other in a longitudinal direction to provide a current in said longitudinal direction through said liquid metal, and wherein liquid metal is ejected through said orifice in said longitudinal direction.

18. The apparatus of claim 1, wherein said magnetic field produced by said current through said liquid metal contributes more to radially inward directed forces that cause metal to flow through said orifice than any permanent magnet.

19. The apparatus of claim 1, wherein said apparatus does not employ a permanent magnet to provide a magnetic field that forces said metal to flow through said orifice.

20. The apparatus of claim 1, wherein said magnetic field produced by said current through said liquid metal contributes more to radially inward directed forces that cause metal to flow through said orifice than any conductive coil.
